(19) United States
(12) Patent Application Publication
(10) Pub. No.: US 2003/0137342 A1
(43) Pub. Date: Jul. 24, 2003

(54) Low-voltage bandgap reference circuit

(76) Inventor: Ion E. Opris, San Jose, CA (US)

Correspondence Address: THOMAS A. WARD, FLIESLER DUBB MEYER & LOVEJOY LLP, Four Embarcadero Center, Fourth Floor, San Francisco, CA, 94111-4156, US

(21) Appl. No.: 10/375,472

(22) Filed: Feb. 27, 2003

Related U.S. Application Data
(62) Division of application No. 10/141,597, filed on May 7, 2002, now Pat. No. 6,549,065.
Application No. 10/141,597 is a division of application No. 09/804,779, filed on Mar. 13, 2001, now Pat. No. 6,407,622.

(51) Int. Cl. G05F 1/10

(52) U.S. Cl. 327/539

(57) ABSTRACT

A low-voltage reference circuit is provided wherein (i) the output voltage can be set to be a fraction of the silicon bandgap voltage of 1.206 volts, or on the order of 0.9 volts, (ii) the output voltage can have a zero thermal coefficient (TC), and (iii) the operating supply voltage Vcc can be less than 1.5 volts, or on the order of 1.1 volts. In one embodiment, the reference circuit modifies a conventional Brokaw bandgap circuit to lower both the required Vcc level and the output voltage by a constant offset. Referring to FIG. 3, the modification includes adding bipolar transistor (Q6), an opamp (A3) and resistors (R5, R6 and R7). In another embodiment, the reference circuit modifies a conventional circuit with PNP transistors connected to the substrate, referring to FIG. 4, by adding current source I6, NMOS transistor M3, opamp A4 and resistors R8-R10. A further embodiment modifies FIG. 4, referring to FIG. 5, by omitting the current source I6, and moving the location of resistor R4.

### RELATED APPLICATIONS

This application claims priority to divisional application Ser. No. 10/141,597, filed May 7,2002, which is a divisional of application Ser. No. 09/804,7-79, filed Mar. 13, 2001.

### I. BACKGROUND OF THE INVENTION

A. Field of the Invention

The present invention relates to constant voltage reference circuits. More particularly, the present invention relates to a bandgap voltage reference circuit wherein (i) the output voltage can be low and set relative to the silicon bandgap voltage, (ii) the output voltage can have a zero TC, and (iii) the operating supply voltage V_{cc} can be limited.

B. Description of the Related Art

So-called bandgap reference circuit produces an output voltage that is approximately equal to the silicon bandgap voltage of 1.206 V (hereinafter termed simply the “bandgap voltage”) with a zero temperature coefficient (“TC”).

### 1. FIG. 1—PRIOR ART

FIG. 1 shows a prior art bandgap reference circuit, sometimes called the Brokaw bandgap circuit. This circuit is built with current sources I₁-I₂, npn bipolar junction transistors Q₁-Q₂, resistors R₁-R₂, and operational amplifier (“opamp”) A₁. Opamp A₁ has a negative input terminal (node n₁), a positive input terminal (node n₂), and an output terminal (node n₃).

Current sources I₁-I₂ are implemented so that each current source produces a substantially equal current I. This can be done, for example, by utilizing p-channel MOS transistors. In such an implementation, the source of each PMOS transistor is connected to V_{cc}, and the gates of the PMOS transistors are connected together in a current mirror configuration to node n₁.

Transistor Q₂ is N times larger in size than transistor Q₁. Initially, with Q₂ larger than Q₁ and equal current from I₁-I₂, the voltage across Q₁will be N times larger than the voltage across Q₂. Thus, node n₁ will be driven higher than node n₂. This will cause the voltage at node n₃ to increase. The bases of transistors Q₁ and Q₂ are connected to node n₃, so increasing the voltage at node n₃ causes current I from current sources I₁-I₂ to increase. Current I will increase until the voltage across resistor R₁ balances the voltage difference between transistors Q₁ and Q₂.

The equilibrium value for the current I is given by

$$I = \frac{Δ {V}_{BE}}{{R}_{1}} \qquad ( 1 )$$

The difference in the base-emitter voltage of the two transistors Q₁ and Q₂ is expressed as

$$Δ {V}_{BE} = \frac{kT}{q} \cdot ln ( N ) \qquad ( 2 )$$

Because ΔVB_{E} is a function of thermal voltage kt/q, it is said to be proportional to absolute temperature (PTAT).

The output voltage Vₒᵤₜ₁, in FIG. 1 is expressed as

$${V}_{out1} = {V}_{{BE}_{1}} + \frac{2 \cdot {R}_{2}}{{R}_{1}} \cdot Δ {V}_{BE} \qquad ( 3 )$$

Three observations can be made about Vₒᵤₜ₁. First, for a certain ratio of the resistors R₁ and R₂, Vₒᵤₜ₁ becomes equal to the silicon bandgap voltage. Second, Vₒᵤₜ₁ does not depend on the absolute value of the resistors used, which is hard to control. Third, Vₒᵤₜ₁ is temperature independent—that is, it has a zero TC.

### B. FIG. 2—PRIOR ART

Most modem CMOS processes have only substrate pnp bipolar junction transistors available. In this case the collector of the pnp transistor is forced to be the VSS/ground node. The configuration for a bandgap reference circuit using this type of bipolar junction transistor is shown in FIG. 2.

The circuit of FIG. 2 is built with current sources I₃-I₅, pnp bipolar junction transistors Q₃-Q₅, resistors R₃-R₄, and opamp A₂. Opamp A₂ has a negative input terminal (node n₄), a positive input terminal (node n₅), and an output terminal (node n₆).

Current sources I₃-I₅ are implemented so that each current source produces a substantially equal current I. As described above, this can be done by utilizing PMOS transistors.

Transistor Q₄ is N times larger in size than transistors Q₃ and Q₅. Initially, with Q₄ larger than Q₃ and Q₅ and equal current from I₃-I₅, the voltage across Q₃ and Q₅ will be N times larger than the voltage across Q₄. Thus, node n₄ will be driven higher than node n₅. This will cause node n₆ to increase, causing the current I from current sources I₃-I₅ to increase. Current I will increase until the voltage across resistor R₃ balances the voltage difference between transistor Q₄ and transistors Q₃ and Q₅.

In this case, the output voltage Vₒᵤₜ₂ in FIG. 2 is expressed as

$${V}_{out2} = {V}_{{BE}_{5}} + \frac{{R}_{4}}{{R}_{3}} \cdot Δ {V}_{BE} \qquad ( 4 )$$

As with Vₒᵤₜ₁ in FIG. 1, Vₒᵤₜ₂ can be set equal to the silicon bandgap voltage, Vₒᵤₜ₂ is temperature independent, and Vₒᵤₜ₂ does not depend on the absolute value of the resistors used.

The prior art circuits of FIGS. 1 and 2 cannot work with supply voltages below about 1.5 V, since the bandgap voltage with a zero TC is about 1.2 V for silicon. Many applications, however, require the voltage reference circuit to operate with a voltage supply below 1.5 V. The present invention presents such a circuit.

### II. SUMMARY OF THE INVENTION

In accordance with the present invention, a bandgap voltage reference circuit is provided wherein (i) the output voltage can be a fraction of the silicon bandgap voltage, (ii) the output voltage can have a zero TC, and (iii) the operating supply voltage can be less than 1.5 V.

In one embodiment of the present invention, the prior art Brokaw bandgap circuit of FIG. 1 is modified so that the operating supply voltage Vcc is lowered together with the output voltage by a constant offset. Referring to FIG. 3, the offset is created using an additional npn bipolar junction transistor (Q2), an opamp (A3) and a plurality of resistors (R5, R6 and R7).

In further embodiments of the present invention, the prior art bandgap reference circuit of FIG. 2 is modified so that the operating supply voltage is lowered together with the output voltage by a constant offset. In one embodiment, referring to FIG. 4, the offset is created using an additional current source I6, NMOS transistor M3, opamp A4, and resistors R8-R10. In another embodiment the offset is created, referring to FIG. 5, by modifying FIG. 4 to omit current source I6, and the resistor R4 shown connected in FIG. 4 is moved to the emitter of transistor Q5.

### III. BRIEF DESCRIPTION OF THE DRAWINGS

Further details of the present invention are explained with the help of the attached drawings in which:

FIG. 1 is a circuit diagram showing the prior art Brokaw bandgap reference circuit;

FIG. 2 is a circuit diagram showing a prior art bandgap reference circuit implemented with substrate pnp bipolar junction transistors;

FIG. 3 is a circuit diagram showing a low-voltage reference circuit in accordance with the present invention;

FIG. 4 is a circuit diagram showing a low-voltage reference circuit in accordance with the present invention; and

FIG. 5 is a circuit diagram showing a low-voltage reference circuit in accordance with the present invention.

### IV. DETAILED DESCRIPTION

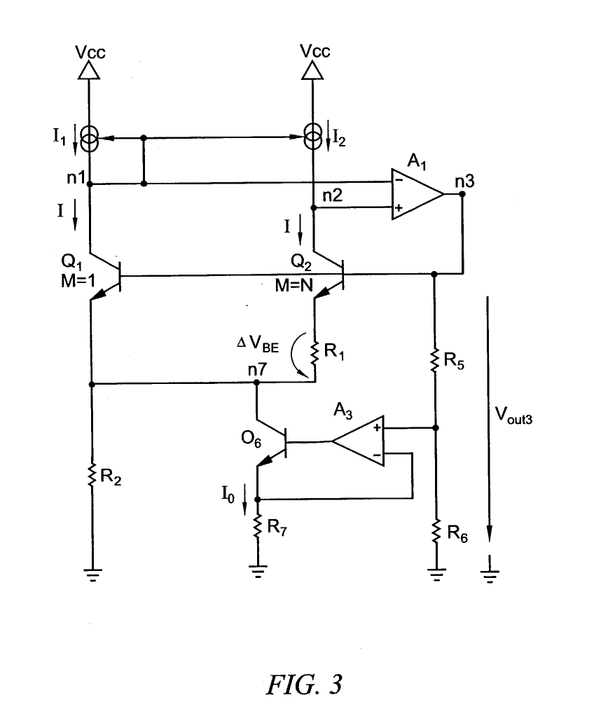

### A. FIG. 3

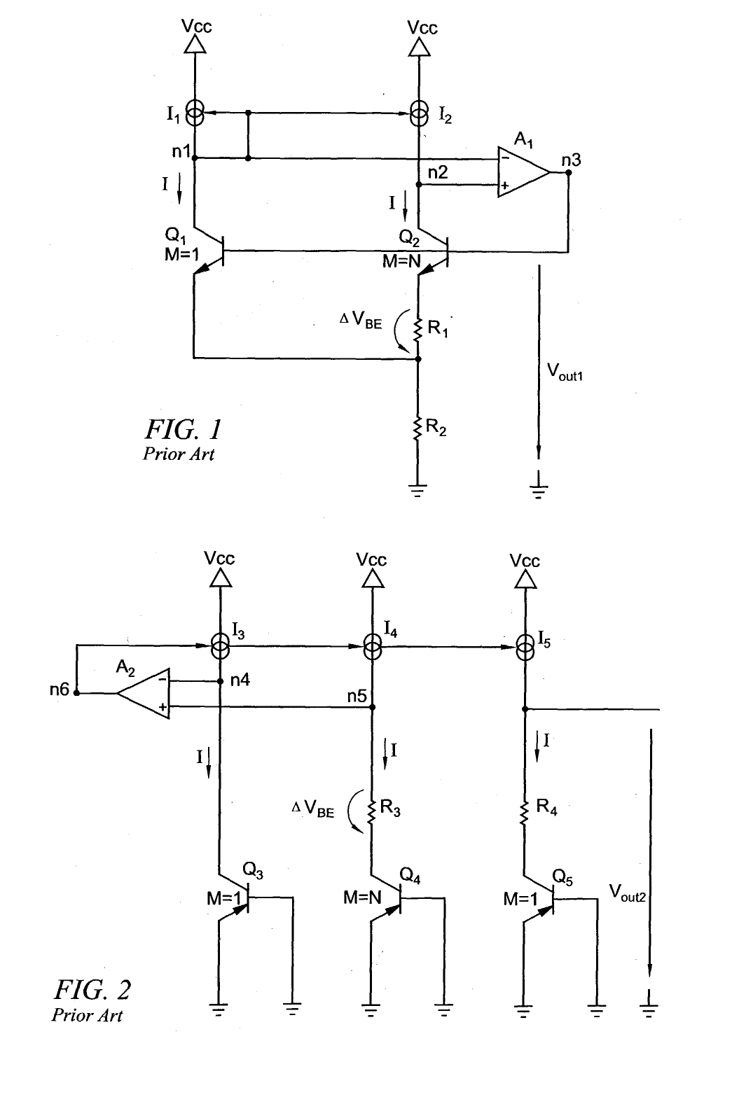

FIG. 3 shows a low-voltage reference circuit in accordance with the present invention. Like the prior art Brokaw bandgap circuit shown in FIG. 1, the circuit of FIG. 3 contains current sources I₁-I₂, npn bipolar junction transistors Q₁-Q₂, resistors R₁-R₂, and opamp A₁. Opamp A₁ has a negative input terminal (node n₁), a positive input terminal (node n₂), and an output terminal (node n₃). In addition, the circuit of FIG. 3 comprises an npn bipolar junction transistor Q₆, resistors R₅-R₇, and opamp A₃.

The output of opamp A₃ drives the base of transistor Q₆, which has a collector drawing an offset current from node n₇. This offset current I_{O} is directed through resistor R₇. The voltage on R₇ is set by the R₅-R₆ tap from the output voltage Vₒᵤₜ₃ using opamp A₃. Thus, the magnitude of offset current I_{O} through R₇ is expressed as

$${I}_{O} = \frac{{R}_{6}}{{R}_{5} + {R}_{6}} \cdot \frac{1}{{R}_{7}} \cdot {V}_{out3} \qquad ( 5 )$$

Neglecting all of the base currents, the output voltage Vₒᵤₜ₃ in FIG. 3 is determined by

$${V}_{out3} = {V}_{BE1} + 2 \frac{{R}_{2}}{{R}_{1}} \cdot Δ {V}_{BE} - {I}_{O} \cdot {R}_{2} \qquad ( 6 )$$

Recalling equation 2, equation 5 can be rewritten as

Vₒᵤₜ₃=Vₒᵤₜ₁−I_{O}·R₂ (7)

$${V}_{out3} = \frac{{V}_{out1}}{1 + \frac{{R}_{4}}{{R}_{3} + {R}_{4}} \cdot \frac{{R}_{2}}{{R}_{5}}} \qquad ( 8 )$$

Thus, for certain resistor ratios, Vₒᵤₜ₃ can be made to be an exact fraction of the bandgap voltage, with a zero TC.

The supply voltage V_{cc} must be set sufficiently high so that Q₆ is maintained in saturation. The output voltage Vₒᵤₜ₃ has to be set sufficiently high so that transistors Q₁ and Q₂ are turned on. In one embodiment, Vₒᵤₜ₃ is preferably chosen to be about 0.9 V, which can be maintained for a supply voltage Vcc as low as 1.1 V. Further reduction in the operating supply voltage Vcc can be obtained for a reduced temperature range.

Thus, the circuit of FIG. 3 is a bandgap reference circuit wherein (i) the output voltage can be set equal to or less than the silicon bandgap voltage by adjusting resistor ratios, (ii) the output voltage can have a zero TC, and (iii) the operating supply voltage can be less than 1.5 V.

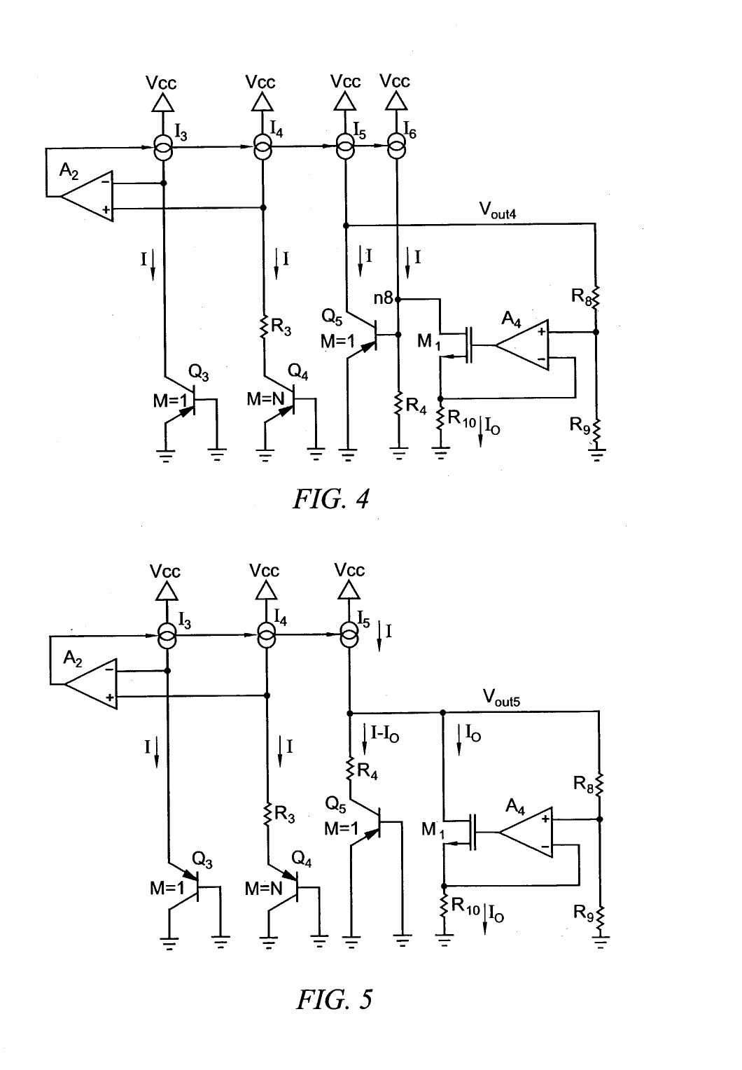

### B. FIG. 4

FIG. 4 shows an embodiment of the present invention implemented with substrate pnp bipolar transistors. As with the circuit shown in FIG. 2, the circuit shown in FIG. 4 comprises current sources I₃-I₅, pnp bipolar junction transistors Q₃-Q₅, opamp A₂, and resistors R₃-R₄. In addition, the circuit shown in FIG. 4 comprises current source I₆, NMOS transistor M₁, opamp A₄, and resistors R₈-R₁₀. Instead of being connected between current source I₅ and transistor Q₅ as in FIG. 2, one terminal of resistor R₄ is connected to the base of transistor Q₅, current source I₆, and the drain of NMOS transistor M₁ (this terminal of resistor R4 is also referred to as node n₈), and the other terminal of resistor R₄ is connected to ground.

These additional components form a controlled current source which generates an offset current. In particular, the output of opamp A₄ drives transistor M₁, which draws an offset current from node n₈. This offset current is directed through resistor R₁₀. The voltage on R₁₀ is set by the R₈-R₉ g tap from the output voltage Vₒᵤₜ₄ using opamp A₄. Thus, the magnitude of offset current I_{O} through R₁₀ is expressed as

$${I}_{O} = \frac{{R}_{9}}{{R}_{8} + {R}_{9}} \cdot \frac{1}{{R}_{10}} \cdot {V}_{out4} \qquad ( 9 )$$

The output voltage Vₒᵤₜ₄ in FIG. 4 is expressed as

Vₒᵤₜ₄=V_{BE}+(I−I_{O})·R₄ (10)

which can also be expressed as

$${V}_{out4} = \frac{{V}_{{BE}_{5}} + \frac{{R}_{4}}{{R}_{3}} \cdot Δ {V}_{BE}}{1 + \frac{{R}_{9}}{{R}_{8} + {R}_{9}} \cdot \frac{{R}_{4}}{{R}_{10}}} \qquad ( 11 )$$

Therefore, for certain resistor ratios, Vₒᵤₜ₄ can be made to be a fraction of the bandgap voltage.

In FIG. 4, the output voltage Vₒᵤₜ₄ has to be set sufficiently high so that transistors Q3, Q4 and Q₅ are turned on. As with the circuit of FIG. 3, in one embodiment Vₒᵤₜ₄ is chosen to be about 0.9 V, which can be maintained for a supply voltage as low as 1.1 V. Further reduction in the operating supply voltage can be obtained for a reduced temperature range.

Thus, the circuit of FIG. 4 is a bandgap reference circuit wherein (i) the output voltage can be set equal to or less than the silicon bandgap voltage by adjusting resistor ratios, (ii) the output voltage can have a zero TC, and (iii) the operating supply voltage can be less than 1.5 V.

### C. FIG. 5

FIG. 5 shows another embodiment of the present invention implemented with substrate pnp bipolar transistors. There are two principal differences between the circuit of FIG. 5 and the circuit of FIG. 4. First, the resistor R₄ is moved to the emitter side of transistor Q₅. Second, current source I₆ is omitted. This means that the transistor Q₅ now has a collector current of I-I_{O}. However, the equation for Vₒᵤₜ₅ is equivalent to the expression for Vₒᵤₜ₄ (eqn. 11). Therefore, for certain resistor ratios, Vₒᵤₜ₅ can be made to be a fraction of the bandgap voltage.

In FIG. 5, as in FIG. 4, the output voltage Vₒᵤₜ₅ has to be set sufficiently high so that transistors Q3, Q4 and Q5 are turned on. In one embodiment for FIG. 5, Vₒᵤₜ₅ is preferably chosen to be about 0.9 V, which can be maintained for a supply voltage as low as 1.1 V. Further reduction in the operating supply voltage can be obtained for a reduced temperature range.

Thus, the circuit of FIG. 5 is a bandgap reference circuit wherein (i) the output voltage can be set equal to or less than the silicon bandgap voltage by adjusting resistor ratios, (ii) the output voltage can have a zero TC, and (iii) the operating supply voltage can be less than 1.5 V.

Although the present invention has been described above with particularity, this was merely to teach one of ordinary skill in the art how to make and use the invention. Many additional modifications will fall within the scope of the invention. Thus, the scope of the invention is defined by the claims which immediately follow.

What is claimed is:

1. A low-voltage reference circuit, comprising:
a first current source (I3);
a second current source (I4);
a third current source (I5);
a first bipolar junction transistor (Q3) having an emitter connected to the first current source (I3), and a collector and base connected to VSS;
a second bipolar junction transistor (Q4) having an emitter connected to the second current source (14), and a collector and base connected to VSS;
a third bipolar junction transistor (Q5) having an emitter, and having a collector and base connected to VSS;
an NMOS transistor (M1) having a drain connected to the third current source (I5), a source, and a gate;
a first operational amplifier (A1) having an inverting (−) input connected to the first current source (I3), a non inverting (+) input connected to the second current source (I4), and an output connected to drive the first, second and third current sources (I3-I5);
a second operational amplifier (A4) having a non inverting (+) input, an inverting (−) input connected to the source of the NMOS transistor (M1 ) and having an output connected to the gate of the NMOS transistor (M1);
a first resistor (R3) having a first terminal connected to the second current source (I4) and having a second terminal connected to the emitter of the second transistor (Q4);
a second resistor (R4) having a first terminal connected to the third current source (I5), and having a second terminal connected to the emitter of the third transistor (Q5);
a third resistor (R8) having a first terminal connected to the third current source (I5), and having a second terminal connected to the non inverting (+) input of the second amplifier (A4);
a fourth resistor (R9) having a first terminal connected to the non inverting (+) input of the second amplifier (A4), and having a second terminal connected to VSS;
a fifth resistor (R10) having a first terminal connected to the inverting (−) input of the second amplifier (A4), and having a second terminal connected to VSS.

2. The low voltage reference circuit of claim 1, wherein a size of the second transistor (Q4) is a multiple of a size of the first transistor (Q3).

3. The low voltage reference circuit of claim 1, wherein the first, second and third current sources (I3-I5) are formed from transistors having substantially equal sizes, with gates driven by the output of the first amplifier (A2).
